(19) United States
(12) Patent Application Publication
(10) Pub. No.: US 2025/0128271 A1
(43) Pub. Date: Apr. 24, 2025

(54) PLASMA CURTAIN GENERATOR IN ATMOSPHERIC PRESSURE STATE USING HIGH VOLTAGE AND MAGNETIC FORCE AND LOW-VACUUM INCINERATION FACILITY FOR LOW- AND INTERMEDIATE-LEVEL RADIOACTIVE WASTE TREATMENT USING SAME

(71) Applicants: Horim KANG, Seoul (KR); Inhan KANG, Seoul (KR); Hae KANG, Seoul (KR)

(72) Inventors: Horim KANG, Seoul (KR); Inhan KANG, Seoul (KR); Hae KANG, Seoul (KR)

(21) Appl. No.: 18/709,466

(22) PCT Filed: Nov. 11, 2022
(86) PCT No.: PCT/KR2022/017784

§ 371 Date: Dec. 23, 2024

(30) Foreign Application Priority Data
Nov. 11, 2021 (KR) 10-2021-0154789
Aug. 19, 2022 (KR) 10-2022-0104245

(51) Int. Cl. B03C 3/38; B03C 3/41; G21F 9/32; H05H 1/46

(52) U.S. Cl. CPC B03C 3/383; B03C 3/41; G21F 9/32; H05H 1/46; B03C 2201/08; H05H 2245/80

(57) ABSTRACT

According to one embodiment of the present disclosure, there is provided a plasma curtain generator comprising: a cylindrical magnet; a cylindrical copper tube disposed inside the cylindrical magnet; and at least one electrode rod disposed along a central axis of the cylindrical copper tube, wherein a high voltage is applied between the cylindrical copper tube and the electrode rod to continuously generate plasma in an atmospheric pressure state, and the cylindrical magnet provides a magnetic force for maintaining the plasma within a certain space inside the cylindrical copper tube. The plasma curtain generator may be installed in a chimney into which an exhaust gas flows from the incineration to reduce the pollutants contained in the exhaust gas in incineration facilities treating household or industrial waste, or in incineration facilities treating low- and intermediate-level radioactive waste.

### TECHNICAL FIELD

The present disclosure relates to the generation and maintenance of plasma in a certain space in an atmospheric pressure state, and more specifically, to a plasma curtain generator in a common atmospheric pressure state using a high voltage and a magnetic force and a low-vacuum incineration facility for low- and intermediate-level radioactive waste treatment using the plasma curtain generator.

### BACKGROUND ART

The content described hereinbelow merely provides background information on the present disclosure and does not constitute the prior art.

The state of material may be divided into solid, liquid, and gas. When energy is applied to a gaseous material, electrons are separated from atoms or molecules, creating a plasma state in which electrons and ions exist.

Plasma may be classified into atmospheric-pressure plasma and low-pressure plasma depending on the pressure generated. Further, plasma discharge may be divided into thermal plasma discharge and non-thermal plasma discharge depending on the method of generating plasma. Thermal plasma is a method of ionization by heating using gas or the like, while non-thermal plasma is a method of ionization by minimizing the heating of gas and heating electrons.

Plasma is divided into Corona, Arc, Glow, and Spark discharge. It has the disadvantage of being generally difficult to handle and dangerous due to the risk of high voltage, which is the basis of plasma discharge, and because it occurs very instantaneously. Currently, low-temperature plasma is mostly widely used in a semiconductor manufacturing process, ozone generation, and electrostatic dust collection. Further, thermal plasma is applied to high-temperature and high-strength new material and surface treatment, special environmental waste treatment and new renewable energy development, and nuclear reactor and nuclear fusion reactor material development.

Meanwhile, the incineration treatment of combustible waste, including household waste and industrial waste, requires a solution to pollutants (dust, hydrogen chloride, sulfur oxides, nitrogen compounds, dioxin, heavy metals, etc.) discharged to the atmosphere during incineration, but a fundamental solution has not yet been found.

In particular, in the case of low- and intermediate-level radioactive waste, incineration treatment not only has an excellent waste volume reduction effect, but also reduces risks that may occur during transportation and storage by converting the waste into an inert or less reactive ‘ash’ form. Thus, an incineration and landfill method is attracting attention as a solid waste disposal method. The incineration treatment of combustible waste has many advantages. Since radionuclides or radioactive particles are contained in the exhaust gases generated when incinerating waste, it is required to remove radioactive materials by treating the exhaust gases.

### PRIOR ART DOCUMENT

### Patent Document

(Patent Document 0001) Korean Patent No. 10-1980876 (2019 May 15), “DBP plasma exhaust gas reduction device”

(Patent Document 0002) Korean Patent No. 10-0866328 (2008 Oct. 27), “Plasma burner and diesel particulate filter trap”

(Patent Document 0003) Korean Patent No. 10-1582625 (2015 Dec. 29), “Concurrently decreasing system for NOX and PM of diesel engine using plasma”

(Patent Document 0004) Korean Patent No. 10-1562856 (2015 Oct. 19), “Plasma torch system and method for treatment of all combustible and non-combustible household waste or hospital waste using the same”

(Patent Document 0005) Korean Patent No. 10-0323352 (2002 Jan. 23), “Mobile tritium removal device”

(Patent Document 0006) Korean Patent No. 10-1563199 (2015 Oct. 20), “Apparatus and method of removing tritium”

(Patent Document 0007) Korean Patent No. 10-1478895 (2014 Dec. 26), “Process for synthesizing organosilica having ferrocyanide”

### DETAILED DESCRIPTION OF INVENTION

### Technical Problems

According to one embodiment of the present disclosure, the present disclosure provides a plasma curtain generator that can continuously generate very powerful and high-temperature plasma within a certain space in an atmospheric pressure state simply by using only high voltage and the magnetic force of a magnet without the need for complicated mechanical devices or fossil fuels.

The present disclosure is to reduce or remove various pollutants that spread into the atmosphere during incineration treatment by guiding them to a plasma curtain formed by a plasma curtain generator, and to partially remove low- and intermediate-level radioactive waste.

### Technical Solution

At least one aspect of the present disclosure provides a plasma curtain generator comprising: a cylindrical magnet; a cylindrical copper tube disposed inside the cylindrical magnet; and at least one electrode rod disposed along a central axis of the cylindrical copper tube, wherein a high voltage is applied between the cylindrical copper tube and the electrode rod to continuously generate plasma in an atmospheric pressure state, and the cylindrical magnet provides a magnetic force for maintaining the plasma within a certain space inside the cylindrical copper tube.

The plasma curtain generator may comprise a first insulating layer disposed between the cylindrical copper tube and the cylindrical magnet and further comprise a second insulating layer disposed on an inner surface of the cylindrical copper tube.

In some embodiments, the electrode rod may be formed of a heat-resistant non-ferrous metal, and preferably be a carbon rod or a tungsten rod. In other embodiments, the electrode rod may comprise an iron core and an insulating material surrounding the iron core.

The plasma curtain generator may comprise a plurality of electrode rods arranged at equal intervals around a central axis of the cylindrical copper tube.

The cylindrical magnet may comprise a plurality of ring magnets arranged such that the same poles or different poles face each other while being spaced apart from each other by a predetermined distance, and a fixing structure coupling the plurality of ring magnets to each other. The cylindrical magnet may be a permanent magnet or an electromagnet.

The type of generation of the plasma may be DC plasma or AC plasma. Therefore, a high voltage applied between the cylindrical copper tube and the electrode rod may be DC voltage or AC voltage.

The plasma curtain generator may be installed in a chimney into which an exhaust gas flows from the incineration to reduce the pollutants contained in the exhaust gas in incineration facilities treating household or industrial waste, or in incineration facilities treating low- and intermediate-level radioactive waste.

In addition, at least one aspect of the present disclosure provides a low- and intermediate-level radioactive waste incineration facility using the aforementioned plasma curtain generator. The low- and intermediate-level radioactive waste incineration facility comprises an electromagnet type transfer tray including a transfer conveyor that transfers low- and intermediate-level radioactive pollutants within an internal space in a low-vacuum state; and incineration equipment incinerating or vaporizing the low- and intermediate-level radioactive pollutants, wherein the incineration equipment is connected to a first chimney having the plasma curtain generator.

The plasma curtain generator provided in the first chimney may reach the internal space of the incineration facility to a low-vacuum state using an air conditioner and a vacuum pump and prevent contaminated air from leaking out when incineration or vaporization of the low- and intermediate-level radioactive pollutants has been completed.

A wall, a floor, and a ceiling surrounding the internal space of the incineration facility may be formed as a hexagonal non-ferrous metal modular structure to prevent warping due to low vacuum in the internal space.

The plasma curtain generator connected to the first chimney may be disposed in the internal space of the incineration facility. The plasma curtain generator provided in a second chimney into which air flows from the internal space may be disposed outside the ceiling of the internal space.

### Effect of Invention

A plasma curtain generator disclosed herein can generate strong and continuous plasma, that is, a plasma curtain, within an adjustable spatial range in an atmospheric pressure state, rather than locally generated plasma. In particular, by adjusting the magnetic flux density and size (inner diameter, outer diameter, and thickness) of a magnet and the intensity of high voltage, which are closely related to a plasma generation range, it is possible to obtain plasma from a small spatial range to a very large spatial range.

A plasma curtain generator disclosed herein requires a high voltage applied to an electrode rod and a copper tube and a magnet providing a strong magnetic field that maintains plasma in a certain space, and can simply generate a powerful plasma curtain without any other type of mechanical device or fuel. In addition, a mechanical structure is very simple, so malfunctions are rare and parts can be easily replaced in case of malfunction.

Further, technologies disclosed herein can easily remove contamination sources before they spread into the atmosphere or spread into a specific space, using a plasma curtain to fundamentally remove pollutants that spread various harmful gases or large amounts of fine dust into the atmosphere. In particular, the plasma curtain generator is easy to adjust the range of plasma generation, making it suitable for removing contaminants in various spatial ranges required for an incineration facility.

Technologies disclosed herein can be used to induce collisions with a powerful plasma curtain to cross-collapse various hazardous materials that may cause incomplete combustion and leak pollutants to the outside during incineration or vaporization treatment of radioactive waste, etc. into less dangerous particles. This has a special distinction in that it can be treated with very simple methods of incineration and vaporization, rather than through a complex process like the previous technologies. In particular, by making an entire incineration facility in a low vacuum state, it has the effect of completely blocking the outflow of radioactive contaminants, etc. When a solid residue after an incineration process and a heavy type of liquid radioactive materials that remain without vaporization are transported to a permanent disposal site according to an existing treatment method, it has the great advantage of being able to reduce the amount of radioactive pollutant waste to a very small range.

### BRIEF DESCRIPTION OF THE DRAWING

FIG. 1 is a partial sectional perspective view of a plasma curtain generator according to a first embodiment of the present disclosure.

FIG. 2 is a perspective view of an exemplary magnet assembly in which a pair of ring magnets are arranged such that the same poles face each other.

FIG. 3 is a perspective view of an exemplary magnet assembly in which a pair of ring magnets are arranged such that different poles face each other.

FIG. 4 is an actual photograph showing the occurrence of a plasma curtain experimentally obtained in a bipolar array.

FIG. 5 is an actual photograph showing the occurrence of a plasma curtain experimentally obtained in a homopolar array.

FIG. 6 is a partial sectional perspective view of a plasma curtain generator according to a second embodiment of the present disclosure.

FIG. 7 is a partial sectional perspective view of a plasma curtain generator according to a third embodiment of the present disclosure.

FIG. 8 illustrates a plasma curtain generator according to a fourth embodiment of the present disclosure in a perspective view and a partial sectional perspective view.

FIG. 9 illustrates a plasma curtain generator according to a fifth embodiment of the present disclosure in a perspective view and a partial sectional perspective view.

FIG. 10 is a conceptual diagram showing an exemplary low-vacuum incineration facility for low- and intermediate-level radioactive waste treatment according to some embodiments of the present disclosure.

FIG. 11 is a perspective view illustrating a means of transporting a waste drum containing a radioactive pollutant that may be used in the incineration facility of FIG. 10.

FIG. 12 is a perspective view illustrating a first chimney including a first plasma curtain generator that may be used in the incineration facility of FIG. 10.

FIG. 13 is an exemplary sectional view of a plasma curtain generator that may be used in a first chimney and a second chimney of the incineration facility of FIG. 10.

FIG. 14 is a perspective view illustrating the second chimney that may be used in the incineration facility of FIG. 10.

FIG. 15 is a conceptual diagram illustrating a wall made of non-ferrous metal that may be used in the incineration facility of FIG. 10.

FIG. 16 is a detailed assembly sequence of hexagonal modules that form the wall.

FIG. 17 is a flowchart showing an order in which low- and intermediate-level radioactive waste is treated in the incineration facility of FIG. 10.

### BEST MODE FOR CARRYING OUT THE INVENTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., may be prefixed. These numbers and codes are solely used to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

Herein, various embodiments of a plasma curtain generator that can continuously generate very powerful and high-temperature plasma within a certain space in an atmospheric pressure state are disclosed. Further, a practical example of applying the plasma curtain generator to an incineration facility will be described.

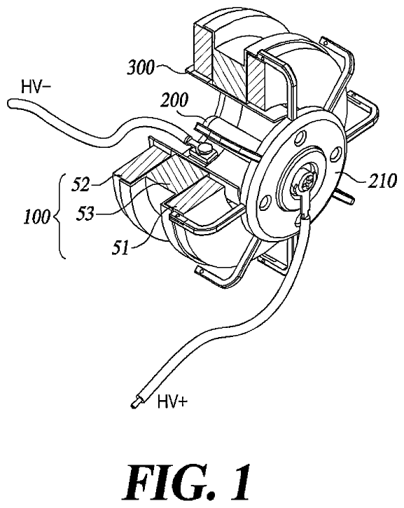

FIG. 1 is a partial sectional perspective view of a plasma curtain generator according to a first embodiment of the present disclosure.

The plasma curtain generator includes a cylindrical magnet 100, a cylindrical copper tube 300 disposed in an internal space of the cylindrical magnet 100, and an electrode rod 200 disposed along the central axis of the cylindrical copper tube 300.

The plasma curtain generator generates continuous plasma by applying a high voltage (e.g., hundreds to thousands of volts) between the cylindrical copper tube 300 and the electrode rod 200. The cylindrical magnet 100 generates a magnetic force to maintain plasma within a certain space inside the cylindrical copper tube 300.

In terms of a charged state, plasma is composed of negatively charged electrons and positively charged ions, and they are subject to Lorentz force (defined as “F=q(E+v*B)”), which is the sum of electric force and magnetic force in an electromagnetic field. Therefore, charged particles that spread through random thermal motion are subject to magnetic force in space, causing the charged particles to rotate. This rotational movement controls the spread of particles through thermal motion, so charged particles are confined in space under the magnetic field.

The electrode rod 200 may be a carbon rod or a tungsten rod, and may be made of another non-ferrous metal that has strong heat resistance and high electrical conductivity. The electrode rod 200 is coupled to the cylindrical magnet 100 by the fixing structure 210 to be aligned along the central axis of the cylindrical copper tube 300.

The cylindrical copper tube 300 disposed between the cylindrical magnet 100 and the electrode rod 200 prevents plasma from directly contacting the cylindrical magnet 100. Further, since copper has high electrical conductivity without interfering with the magnetic flux of the cylindrical magnet 100 and has a fairly high melting point (about 1084 degrees), it is useful as a material for the cylindrical copper tube 300 that is disposed between the cylindrical magnet 100 and the electrode rod 200.

Even if a high voltage is applied to the cylindrical magnet 100 and the electrode rod 200 without the intervention of the cylindrical copper tube 300, plasma may be generated in the magnetic field formed in the internal space of the cylindrical magnet 100. However, due to the high heat of plasma that is in direct contact with the cylindrical magnet 100, there is a problem in that the cylindrical magnet 100 loses its magnetic force when it reaches a certain temperature.

In the cylindrical magnet 100, a pair of magnets 51 and 52 are disposed on a structure 53 such that the same poles or different poles face each other while being spaced apart from each other by a predetermined distance. Thus, the magnetic fluxes of the magnets 51 and 52 in the copper tube 300 may be combined to form a strong magnetic field within the copper tube 300 where plasma is generated.

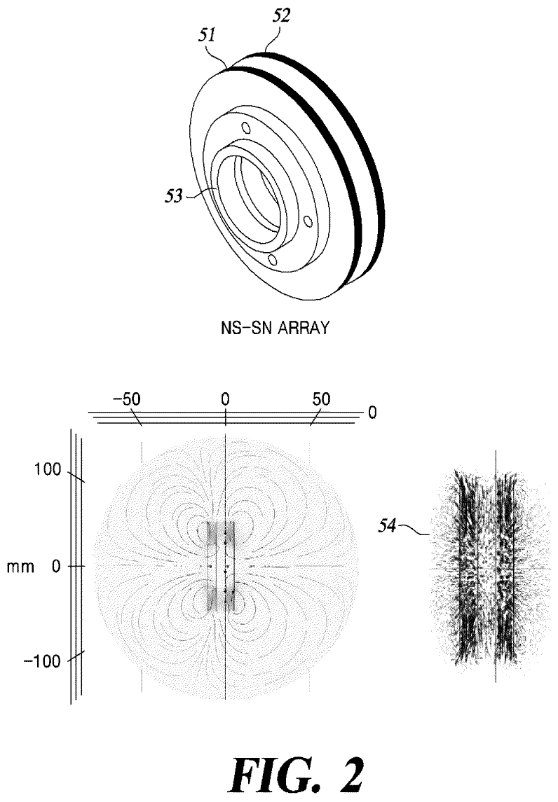

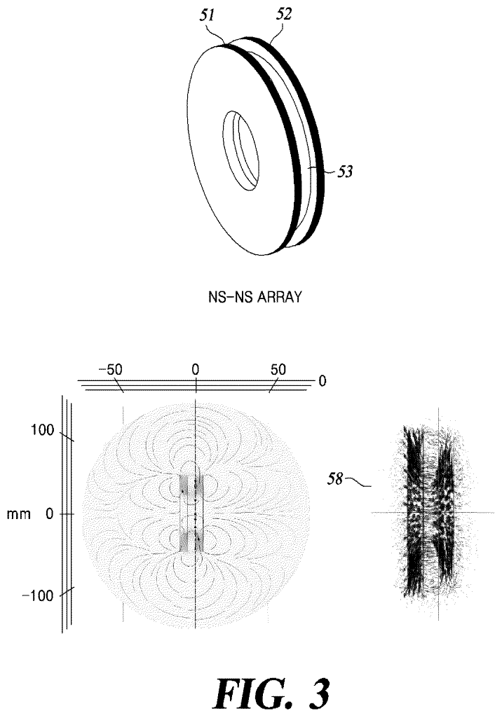

FIG. 2 illustrates the magnet assembly which may be used as the cylindrical magnet 100 and in which a pair of ring magnets 51 and 52 are arranged such that the same poles face each other, and FIG. 3 illustrates the magnet assembly in which a pair of ring magnets 51 and 52 are arranged such that different poles face each other. In the magnet assembly of FIG. 2, because a repulsive force acts between the ring magnet 51 and the ring magnet 52 and pushes the magnets away from each other, the ring magnets 51 and 52 are coupled to the fixing structure 53 and the ring magnets 51 and 52 are fixed to maintain a predetermined distance (e.g., about 10 mm) therebetween. In the magnet assembly of FIG. 3, because an attractive force acts between the ring magnet 51 and the ring magnet 52 and pulls the magnets toward each other, the ring magnets 51 and 52 are coupled to the fixing structure 53 and the ring magnets 51 and 52 are fixed to maintain a predetermined distance (e.g., about 10 mm) therebetween.

As such, the assembly including the pair of ring magnets that are spaced apart from each other provides a high magnetic flux density in a hollow cylindrical space defined along the central axis of the assembly, compared to a structure using a single ring magnet or a structure in which two ring magnets are in complete contact with each other.

In particular, referring to the simulated magnetic-force lines and magnetic flux densities 54 and 58 shown in each of the lower portions of FIGS. 2 and 3, compared to the homopolar array S+S in FIG. 2, the bipolar array S+N in FIG. 3 shows a stronger magnetic flux density by combining the magnetic fluxes of respective ring magnets in the hollow cylindrical space formed along the central axis of the assembly. Therefore, the bipolar array S+N in FIG. 3 may be more advantageous to maintain the plasma within a certain space.

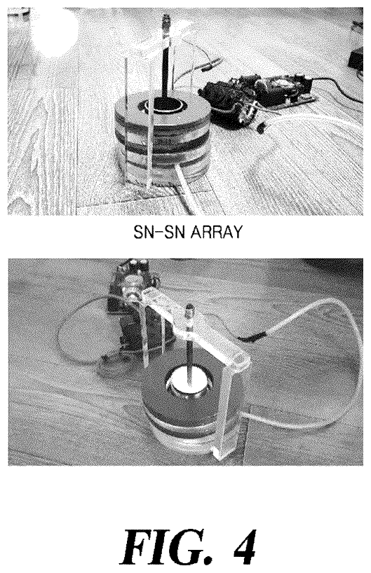

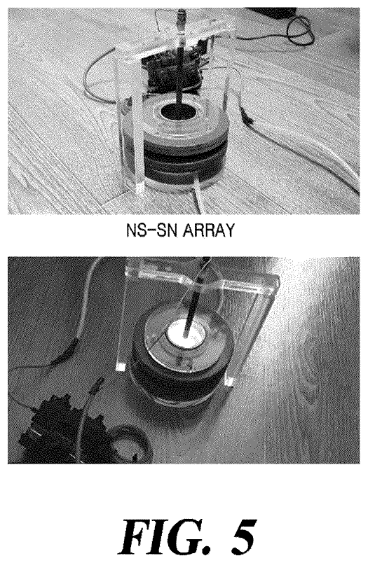

The present inventors experimentally verified plasma generation in the plasma curtain generator with respect to the bipolar array structure in which the ring magnets are arranged such that different poles face each other and the homopolar array structure in which the ring magnets are arranged such that the same poles face each other. FIG. 4 is an actual photograph showing the occurrence of a plasma curtain experimentally obtained in the bipolar array, and FIG. 5 is an actual photograph showing the occurrence of a plasma curtain experimentally obtained in the homopolar array. In the experiment of FIG. 5, the array (i.e., S+S array) in which S poles face each other is used.

When high voltage is applied to the copper tube and the electrode rod in the bipolar array structure, it can be seen in FIG. 4 that a plasma curtain of bright light while rotating violently is generated. Further, when high voltage is applied to the copper tube and the electrode rod in the homopolar array structure, it can be seen in FIG. 5 that a plasma curtain 75 of bright light while rotating violently is generated.

In the above experiments, the inventors measured the magnetic field inside the copper tube using a gauss meter. In the experiment (bipolar array) of FIG. 4, a magnetic field of 37 Gauss was measured inside the copper tube. In the experiment (homopolar array) of FIG. 5, a magnetic field of 33 Gauss was measured inside the copper tube. Unlike FIGS. 4 and 5, in the experiment using a single ring magnet, a magnetic field of 6 Gauss was measured inside the copper tube. As a result, it can be seen that a very clear increase in magnetic flux when two magnets are arranged to be spaced apart from each other can be obtained compared to when a single magnet is used. In particular, it can be seen that the bipolar array is more suitable for maintaining plasma in a certain space and providing rotational force.

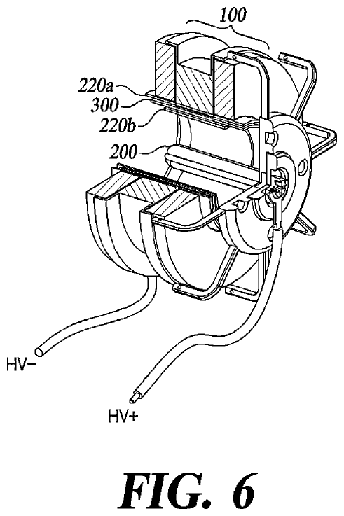

FIG. 6 is a partial sectional perspective view of a plasma curtain generator according to a second embodiment of the present disclosure. Referring to FIG. 6, insulating layers 220a and 220b are disposed between the cylindrical magnet 100 and the cylindrical copper tube 300 and on the inner surface of the cylindrical copper tube 300. The insulating layer may be made of ceramic material. The insulating layer 200a blocks heat from the cylindrical copper tube 300 heated by plasma from being transferred to the cylindrical magnet 100. The insulating layer 200b prevents the cylindrical copper tube 300 from directly contacting high-temperature plasma, thereby preventing the cylindrical copper tube 300 from being excessively heated.

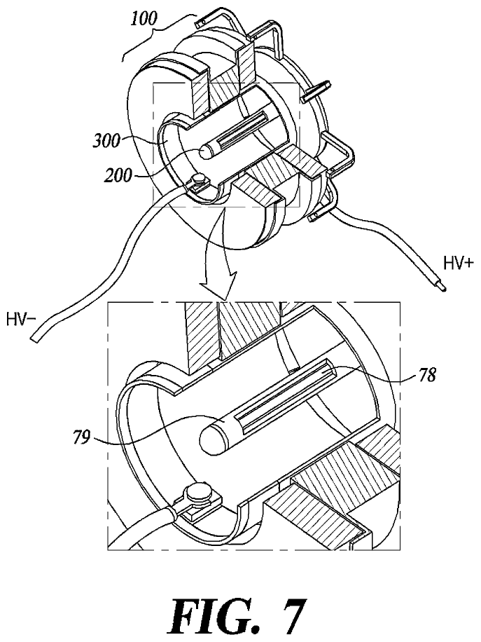

FIG. 7 is a partial sectional perspective view of a plasma curtain generator according to a third embodiment of the present disclosure. In the embodiment of FIG. 7, referring to the partial cross section of the electrode rod 200, it is composed of an iron core 78 of the electrode rod 200 and an insulating material 79 surrounding the iron core. The iron core 78 inside the electrode rod 200 can strengthen or concentrate the magnetic flux formed in the internal space of the cylindrical copper tube 300 by the cylindrical magnet 100.

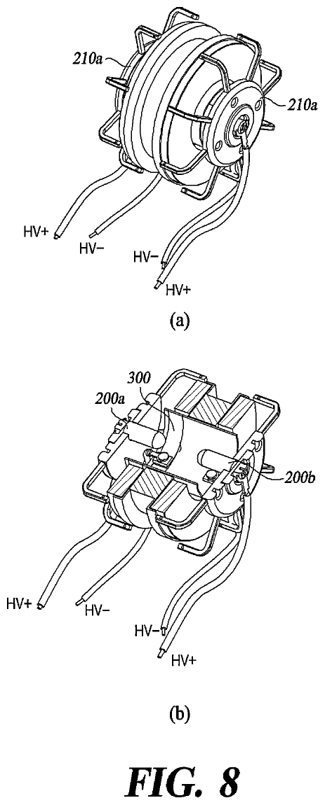

FIG. 8 illustrates a plasma curtain generator according to a fourth embodiment of the present disclosure in a perspective view and a partial sectional perspective view. Referring to FIG. 8, carbon rods 200a and 200b are disposed in left and right openings of the cylindrical copper tube 300, respectively. In such a structure, a plasma layer is formed in the proximity of an end of each of the carbon rods 200a and 200b, so two plasma curtains are generated in a space within the cylindrical copper tube.

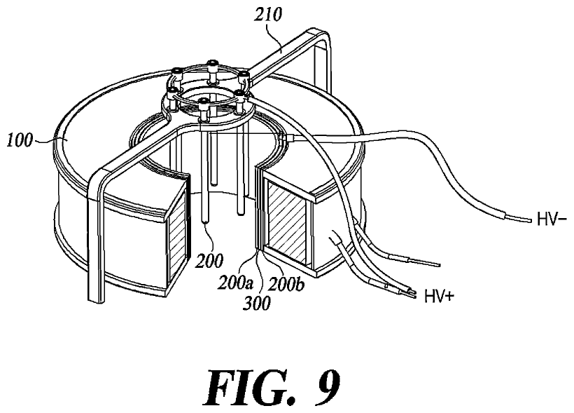

FIG. 9 illustrates a plasma curtain generator according to a fifth embodiment of the present disclosure in a perspective view and a partial sectional perspective view. Referring to FIG. 9, several (six in FIG. 9) electrode rods 200 are arranged at equal intervals around the central axis of the cylindrical copper tube 300 by the fixing structure 210. This structure can ensure an appropriate distance between the electrode rods 200 involved in plasma generation and the cylindrical copper tube 300 in a large-capacity plasma curtain generator in which the cylindrical copper tube 300 with a large inner diameter is used.

In FIG. 9, the cylindrical magnet 100 is composed of an electromagnet to which DC current or AC current is applied. The permanent magnet has limitations on the size that may be manufactured, but the electromagnet has no special limitations on size. In particular, the electromagnet is easy to increase/decrease magnetic force and adjust a polarity, so it is suitable for manufacturing plasma curtain generators of various capacities required in various fields.

In the above embodiments, both the outer and inner circumferences of the copper tube and the magnet that form the plasma curtain generator are cylindrical, and the hollow space formed by the copper tube is depicted as cylindrical. However, it should be understood that they may have various shapes, including square, depending on the embodiment.

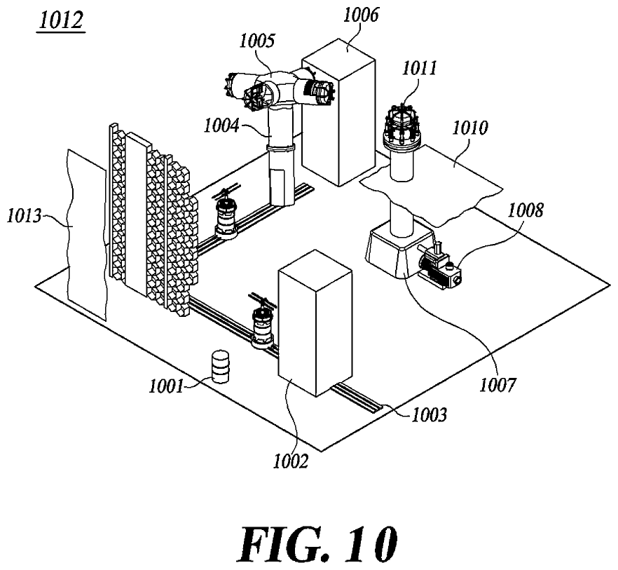

Now, a low-vacuum incineration facility using the above-described plasma curtain device for low- and intermediate-level radioactive waste treatment will be described with reference to FIGS. 10 to 17.

FIG. 10 is a conceptual diagram showing an exemplary low-vacuum incineration facility for low- and intermediate-level radioactive waste treatment according to some embodiments of the present disclosure.

A waste drum 1001 is a drum containing radioactive waste.

An entrance 1002 is a low-vacuum closed facility for passing the waste drum 1001 to a transfer conveyor 1003 among low-vacuum facilities.

The transfer conveyor 1003 serves to transfer the drum 1001 to the incineration facility.

Incineration equipment 1004 is a type of combustion device that incinerates or vaporizes radioactive waste.

A first chimney 1005 is a chimney with four outlets, each equipped with a plasma curtain generator.

An exit 1006 is a closed facility that is the last stage of the transfer conveyor, similarly to the entrance 1002.

An air conditioner 1007 is an air conditioning device, and is used to guide the contaminated air within the incineration facility generated during incineration or vaporization of radioactive waste to the plasma curtain.

A vacuum pump 1008 serves to forcibly discharge the air within the incineration facility, and its purpose is to maintain a low-vacuum within the incineration facility.

A second chimney 1009 is a chimney having the plasma curtain generator.

A second plasma curtain 1011 is the last plasma curtain and includes a plasma curtain that once again filters radioactive contaminants that may remain or may be present in the incineration facility. This is the last facility that leads to the low-vacuum facility, and simultaneously forms a group with the air conditioner and vacuum pump.

An interior 1012 refers to the entire internal space of the incineration facility, surrounded by a floor, a wall 1013, and a ceiling 1010. This means that the entire incineration facility is in a low-vacuum state. Since the interior has a pressure lower than the general atmospheric pressure, radioactive contaminants within the incineration facility may be prevented from leaking out.

When the waste drum 1001 arrives at the entrance 1002, it has the same air pressure as the outside of the incineration facility. At this time, the entire incineration facility, which is the interior 1012, is closed to maintain low-vacuum, and the entrance 1002 is closed before the waste drum moves to the transfer conveyor 1003. When radioactive waste arrives at the incineration equipment 1004 and incineration or vaporization begins, the first plasma curtain of the first chimney 1005 operates. The waste drum 1001 on which incineration or vaporization is completed is discharged to the exit 1006.

In particular, even if contaminants generated during incineration or vaporization of radioactive contaminants are removed from the first plasma curtain generator of the first chimney 1005, gas contaminants that may remain in the incineration facility are guided to the second plasma curtain generator 1011 of the second chimney 1007 using the air conditioner 1007 and the vacuum pump 1008. By removing radioactive contaminants that may remain in the incineration facility interior once again, it is possible to ultimately prevent radioactive materials from leaking out.

The first plasma curtain generator of the first chimney 1005 is installed under the ceiling 1010, whereas the second plasma curtain generator 1011 is installed outside the ceiling 1010. In addition to purifying radioactive contaminants that may exist in the interior, it is also used to maintain the entire incineration facility at low-vacuum.

Also, iron should not be used on the plasma curtain side, that is, the first chimney 1005, the ceiling 1010, and the second plasma curtain 1011. This is because it is a facility that includes the plasma curtain and requires a very strong magnetic field. In particular, the ceiling 1010 should not be made of materials that induce magnetic force.

Meanwhile, the wall 1013 of a hexagonal module is to withstand low-vacuum force. This hexagonal modular wall should be installed on the wall, floor, and ceiling to withstand the low-vacuum pressure of the incineration facility.

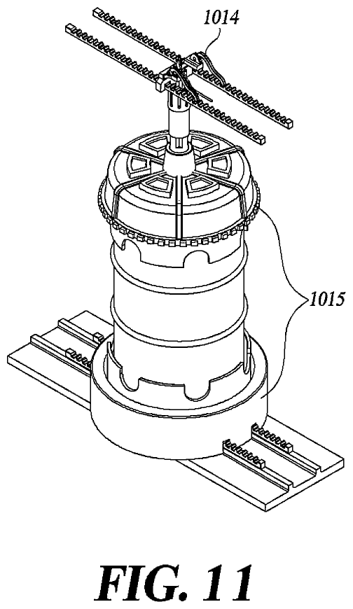

FIG. 11 is a perspective view illustrating a means of transporting a waste drum containing a radioactive pollutant that may be used in the incineration facility of FIG. 10. The key components are a transfer conveyor 1014 and an electromagnet type transfer tray 1015. The electromagnet type transfer tray 1015 is a means of strongly holding the waste drum with magnetic force, thereby preventing the drum containing the radioactive pollutant from falling off during movement, and safely moving it to its destination.

The transfer conveyor 1014 is a device that may move up and down, and serves to move the waste drum 1001 from the outside to the inside of the incineration facility, to safely move it inside the incineration facility, and also safely moves the waste drum that has completed incineration or vaporization to the exit 1006.

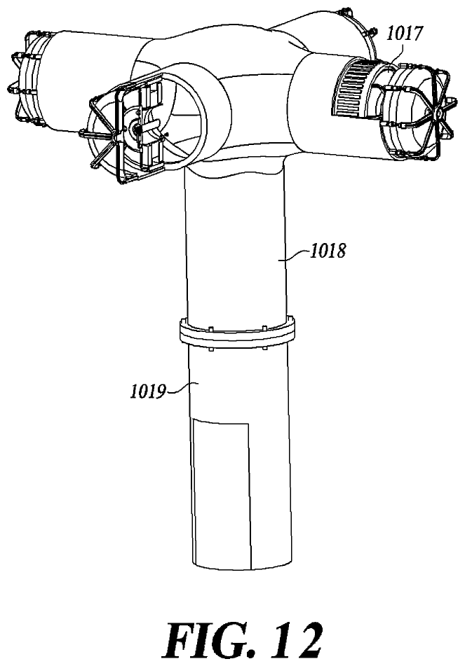

FIG. 12 is a perspective view illustrating the first chimney 1005 including the first plasma curtain generator that may be used in the incineration facility of FIG. 10. Four plasma curtain devices 1017 provided in the first chimney 1005 take into account situations in which unusual situations such as the failure of the plasma curtain generator 1017 occur during incineration. They are intended to alternately operate one or two plasma curtain generators 1017, especially when performing incineration for a long time. Further, an incineration facility 1019 in FIG. 12 should have a completely sealed structure and a separate air inlet should be installed to facilitate oxygen supply.

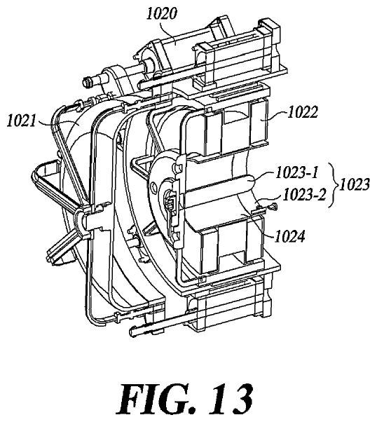

FIG. 13 is an exemplary sectional view of a plasma curtain generator that may be used in a first chimney 1005 and a second chimney 1009 of the incineration facility of FIG. 10. Here, the plasma curtain generator may be implemented according to one or a combination of various embodiments described above.

A cover 1021 is a cover including a hydraulic cylinder 1020, which is used to maintain low vacuum within the incineration facility. The cover serves to block the outflow of radioactive pollutant gas and is immediately closed if any problem occurs within the incineration facility. A magnet 1022 is one of plasma curtain structures and serves to hold the plasma. A high voltage application device 1023 includes a non-ferrous metal 1023_1 such as an electrode rod and a copper tube 1023_2. An ultra-high temperature ceramic 1024 blocks heat generated when plasma is generated from moving toward the magnet and becomes a body that may turn the plasma curtain device into a single system.

Characteristically, in the incineration completion stage, a chimney body 1018 of FIG. 12 and the cover 1021 of FIG. 13 come into contact with each other to block the inflow of air, thereby maintaining the low-vacuum state of the entire incineration facility. Therefore, the plasma curtain generator 1017, along with the air conditioner 1007 and the vacuum pump 1008, contributes to maintaining the low-vacuum state of the entire incineration facility.

In this case, the drum containing the radioactive pollutant after incineration or heating is extracted out. Thereafter, using the air conditioner 1007 and the vacuum pump 1008, interior contaminants that may remain in the incineration facility are guided to the second plasma curtain 1011. Thus, after removing the remaining contaminants within the incineration facility, the final contaminant purification and the closure of the incineration facility are completed by the locking-device function of the hydraulic cylinder 1020 in FIG. 13.

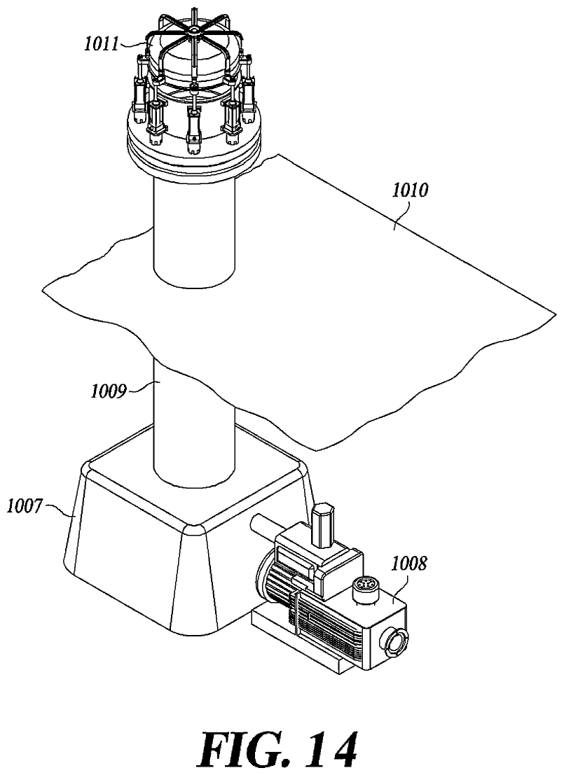

FIG. 14 is a perspective view illustrating the second chimney 1009 that may be used in the incineration facility of FIG. 10. The first plasma curtain of the first chimney 1005 of FIG. 10 with respect to the ceiling 1010 of FIG. 10 and FIG. 14 is located below the ceiling, while the second plasma curtain 1011 provided in the second chimney 1009 of FIG. 10 is installed outside the ceiling. The plasma curtain of the first chimney 1005 in FIG. 10 has a positive function of decomposing various radioactive contaminants generated when radioactive waste transported on the transfer conveyor is incinerated or vaporized. In particular, the second plasma curtain 1011 in FIG. 10 is installed outside the incineration facility, so it serves to remove various pollutants from the air sent from the air conditioner and the vacuum pump to the chimney until low-vacuum is completed. When the low-vacuum is completed, the chimney body 1018 of FIG. 12 and the cover 1021 of FIG. 13 are in complete contact with each other. Its purpose is to remove the final source of contamination within the incineration facility and maintain a low-vacuum state, and the hydraulic cylinder 1020 of FIG. 13, that is, the locking device, plays the final role.

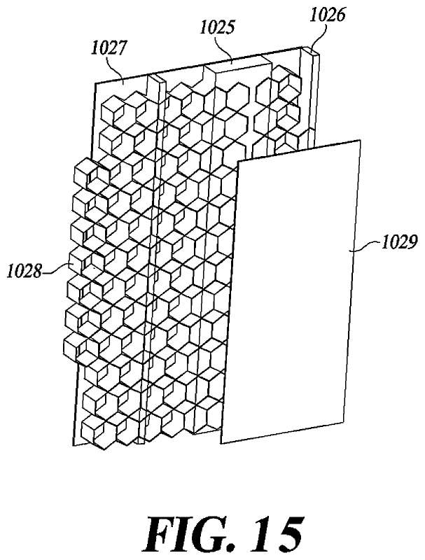

FIG. 15 is a conceptual diagram illustrating walls 1027 and 1029 made of non-ferrous metal that may be used in the incineration facility of FIG. 10. The reason for using the non-ferrous metal is that a large amount of magnetic force is required to generate the plasma curtain, and the wall facility containing iron is an element that interferes with the concentration of the magnetic field. To this end, as shown in FIG. 15, concrete 1025 fills a hexagonal non-ferrous metal module 1028, and a pillar 1026 is also made of non-ferrous metal. If the hexagonal non-ferrous metal module and the concrete are combined into one system and used as a wall or floor to reduce vacuum to the entire incineration facility, the entire incineration facility may be reduced to low vacuum. This prevents various radioactive contaminants generated during incineration or heating from leaking to the outside through the air.

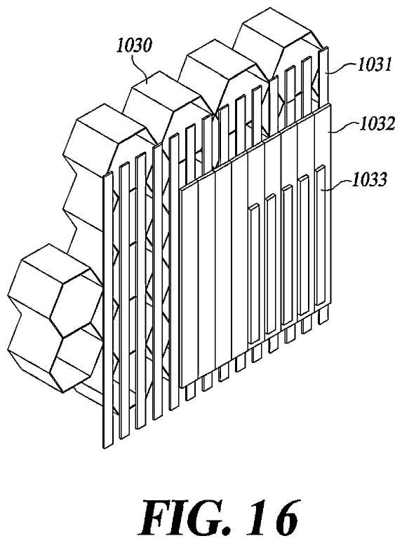

FIG. 16 is a detailed assembly sequence of hexagonal modules that form the wall. Referring to FIG. 16, a thin non-ferrous metal 1031 is welded on a hexagonal non-ferrous metal 1030, and then a wide non-ferrous metal 1032 is welded again on the non-ferrous metal 1031. Subsequently, the wall of the incineration facility is completed by adding a non-ferrous metal 1033 on top of the wide non-ferrous metal 1032 and welding it. When walls, roofs, floors, etc. are constructed and completed in this way, warping inside the incineration facility, such as walls, during low vacuum operation within the incineration facility is prevented.

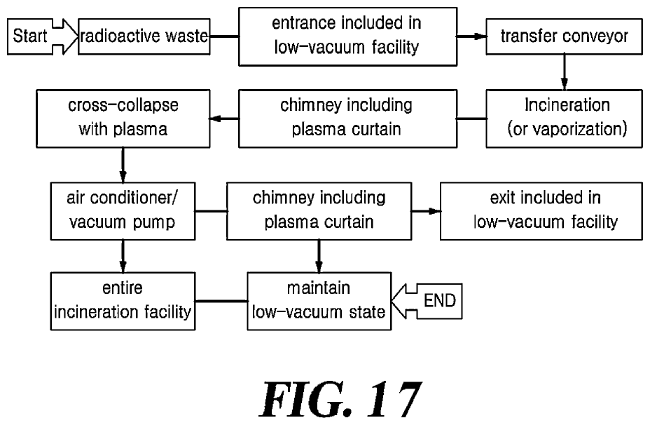

FIG. 17 is a flowchart showing an order in which low- and intermediate-level radioactive waste is treated in the incineration facility of FIG. 10.

Referring to FIG. 17, as described above, the low- and intermediate-level radioactive waste treatment incineration facility is configured to artificially collide various hazardous factors that may cause incomplete combustion and the leakage of pollutants during incineration or vaporization treatment of radioactive waste, etc. with a strong plasma curtain, thereby causing cross-collapse along with the plasma. Thus, it has a special distinction in that it can be treated with very simple methods of incineration and vaporization, and in particular, it has the effect of completely blocking the outflow of radioactive contaminants by making the entire incineration facility in a low vacuum state.

Further, this has a big advantage in that, when solid residues after the incineration process and heavy liquid radioactive materials that remain without vaporization can be transported to a permanent disposal site according to existing treatment methods, it can reduce the amount of waste from radioactive pollutants to a very small range.

The industrial usefulness of the technologies presented in this specification may be summarized as follows. The present disclosure can eliminate pollutants that may spread into the air by directing air pollutants from waste incineration facilities or factories to a plasma curtain. In particular, gaseous radioactive pollutants that may be generated by incinerating or vaporizing radioactive waste in a low-vacuum incineration facility are forcibly induced into the plasma curtain to partially cross-collapse the pollutants, thereby reducing an obstructive factor to the incineration method that may be considered in the treatment of radioactive waste.

Although exemplary embodiments of the present disclosure have been described for illustrative purposes, those skilled in the art will appreciate that various modifications, additions, and substitutions are possible, without departing from the defining features by the embodiments. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

### REFERENCE NUMERIALS

100: cylindrical magnet, 200: electrode rod, 300: cylindrical copper tube, 1001: waste drum, 1002: entrance to a low-vacuum incineration facility, 1003: transfer conveyor, 1004: incineration equipment, 1005: first chimney, 1006: exit, 1007: air conditioner, 1008: vacuum pump, 1009: second chimney, 1010: ceiling, 1011: second plasma curtain, 1012: interior, 1013: wall of a hexagonal module

### CROSS-REFERENCE TO RELATED APPLICATION

This application claims priority to Patent Application No. 10-2021-0154789, filed on Nov. 11, 2021 in Korea, and Patent Application No. 10-2022-0104245, filed on Aug. 19, 2022 in Korea, the entire contents of which are incorporated herein by reference.

1. A plasma curtain generator comprising:
a cylindrical magnet;
a cylindrical copper tube disposed inside the cylindrical magnet; and
at least one electrode rod disposed along a central axis of the cylindrical copper tube,
wherein a high voltage is applied between the cylindrical copper tube and the electrode rod to continuously generate plasma in an atmospheric pressure state, and the cylindrical magnet provides a magnetic force for maintaining the plasma within a certain space inside the cylindrical copper tube.

2. The plasma curtain generator of claim 1, further comprising:
a first insulating layer disposed between the cylindrical copper tube and the cylindrical magnet.

3. The plasma curtain generator of claim 2, further comprising:
a second insulating layer disposed on an inner surface of the cylindrical copper tube.

4. The plasma curtain generator of claim 1, wherein the electrode rod is formed of a heat-resistant non-ferrous metal, and preferably is a carbon rod or a tungsten rod.

5. The plasma curtain generator of claim 1, wherein the electrode rod comprises an iron core and an insulating material surrounding the iron core.

6. The plasma curtain generator of claim 1, further comprising:
a plurality of electrode rods arranged at equal intervals around a central axis of the cylindrical copper tube.

7. The plasma curtain generator of claim 1, wherein the cylindrical magnet comprises:
a plurality of ring magnets arranged such that the same poles face each other while being spaced apart from each other by a predetermined distance; and
a fixing structure coupling the plurality of ring magnets to each other.

8. The plasma curtain generator of claim 1, wherein the cylindrical magnet comprises:
a plurality of ring magnets arranged such that different poles face each other while being spaced apart from each other by a predetermined distance; and
a fixing structure coupling the plurality of ring magnets to each other.

9. The plasma curtain generator of claim 1, wherein the cylindrical magnet is a permanent magnet or an electromagnet.

10. The plasma curtain generator of claim 1, wherein the plasma curtain generator is installed in a chimney into which exhaust gas flows from an incineration facility.

11. A low- and intermediate-level radioactive waste incineration facility using a plasma curtain generator of claim 1, the facility comprising:
an electromagnet type transfer tray including a transfer conveyor that transfers low- and intermediate-level radioactive pollutants within an internal space in a low-vacuum state; and
incineration equipment incinerating or vaporizing the low- and intermediate-level radioactive pollutants,
wherein the incineration equipment is connected to a first chimney having the plasma curtain generator.

12. The low- and intermediate-level radioactive waste incineration facility of claim 11, wherein the plasma curtain generator reaches the internal space of the incineration facility to a low-vacuum state using an air conditioner and a vacuum pump and prevents contaminated air from leaking out when incineration or vaporization of the low- and intermediate-level radioactive pollutants has been completed.

13. The low- and intermediate-level radioactive waste incineration facility of claim 11, wherein a wall, a floor, and a ceiling surrounding the internal space of the incineration facility are formed as a hexagonal non-ferrous metal modular structure to prevent warping due to low vacuum in the internal space.

14. The low- and intermediate-level radioactive waste incineration facility of claim 11, wherein the plasma curtain generator connected to the first chimney is disposed in the internal space of the incineration facility.

15. The low- and intermediate-level radioactive waste incineration facility of claim 14, wherein the plasma curtain generator provided in a second chimney into which air flows from the internal space is disposed outside the ceiling of the internal space.
